(19) United States
(12) Patent Application Publication
(10) Pub. No.: US 2026/0258962 A1
(43) Pub. Date: Sep. 3, 2026

(54) VENTILATION DEVICE HAVING OXYGEN-SUPPLYING FUNCTION AND VENTILATION METHOD USING SAME

(71) Applicant: LG ELECTRONICS INC., Seoul (KR)

(72) Inventors: Bong Gil JEON, Seoul (KR); Kwang Ho SHIN, Seoul (KR)

(73) Assignee: LG ELECTRONICS INC., Seoul (KR)

(21) Appl. No.: 19/165,063

(22) PCT Filed: Mar. 13, 2024
(86) PCT No.: PCT/KR2024/003214

§ 371 Date: Sep. 12, 2025

(30) Foreign Application Priority Data
Mar. 14, 2023 (KR) 10-2023-0033510

(51) Int. Cl. F24F 8/60; B01D 53/04; F24F 11/00; F24F 12/00; F24F 110/70; F24F 110/76

(52) U.S. Cl. CPC F24F 8/60; B01D 53/0438; B01D 53/0446; B01D 53/0454; F24F 11/0001; F24F 12/006; B01D 2256/12; B01D 2257/102; B01D 2259/4508; F24F 2110/70; F24F 2110/76

(57) ABSTRACT

The present invention relates to a ventilation device having an oxygen-supplying function and a ventilation method using same. The present invention may include a ventilation unit (10) and an oxygen supply unit (100). An outdoor air intake path (P1) and an indoor air discharge path (P2) may be provided inside the ventilation unit (10). A compression module (150) for compressing air and an adsorption module (200) for adsorbing nitrogen from the air compressed by the compression module (150) may be arranged inside the oxygen supply unit (100). A first delivery part (110) may be provided between the ventilation unit (10) and the oxygen supply unit (100) and connect the outdoor air intake path (P1) and an internal flow path of the oxygen supply unit (100). A second delivery part (120) may be provided between the ventilation unit (10) and the oxygen supply unit (100) and connect the indoor air discharge path (P2) and the internal flow path of the oxygen supply unit (100). The oxygen supply unit (100) is independently arranged and operated outside the ventilation unit (10), but can be connected to the ventilation unit (10) via the delivery units and operated while sharing gas according to the operation mode. As described above, the oxygen supply unit (100) is independent of and outside the ventilation unit (10), and thus the internal structure of the ventilation device can be simplified.

### TECHNICAL FIELD

The present disclosure relates to a ventilation device and a ventilation method and, more particularly, to a ventilation device having an oxygen-supplying function and a ventilation method.

### BACKGROUND ART

A ventilation device is a device that exhausts contaminated indoor air to the outside and supplies fresh outdoor air to an indoor space, thereby maintaining the freshness of indoor air at a certain level. For example, in public facilities such as school classrooms and hospital rooms, or in single-family units such as apartments and low-rise multi-family housing, indoor air may become rapidly polluted, and thus the ventilation device is highly useful. The ventilation device exchanges stale indoor air with fresh outdoor air, thereby reducing the level of air pollution.

Recently, a heat exchanger that exchanges heat between incoming outdoor air and outgoing indoor air has been added to a ventilation device, thereby minimizing heat loss during a ventilation process. The heat exchanger allow two types of air with different temperatures (air taken in from the outside and air discharged indoors) to flow through different paths, thereby exchanging heat according to the principle of heat exchange.

Meanwhile, in order to maintain a comfortable indoor environment, appropriate concentrations of oxygen and carbon dioxide are required. To this end, a technology that increases oxygen concentration by supplying oxygen while reducing carbon dioxide concentration is also being introduced. For example, Korean Patent Application Publication No. 10-2020-0082835 (Prior Art 1) discloses a ventilation system including an oxygen supply means. In addition, Korean Patent No. 10-2206127 (Prior Art 2) discloses a heat recovery and air purifying ventilation system equipped with an oxygen generator.

The air purifier of Prior Art 1 has a complicated structure involving an exhaust means, an air supply means, and an oxygen supply means and lacks a structure for discharging nitrogen that has been adsorbed and separated from air to the outside. In the ventilation device of Prior Art 2, the oxygen generator is disposed at the air supply part of the ventilation device, but the ventilation device lacks a structure for separating and discharging nitrogen, and does not provide a concrete structure for linking the oxygen generator with the ventilation device, making practical implementation difficult.

In addition, Prior Art 1 and Prior Art 2 are limited in that they merely generate and supply oxygen to an indoor space, but fail to provide appropriate functions tailored to various conditions of the indoor space.

### DISCLOSURE

### Technical Problem

The present disclosure is intended to solve the problems of the conventional technology as described above, and an objective of the present disclosure is to simplify the internal structure of a ventilation device by adding an independent oxygen supply unit to a ventilation unit of the ventilation device.

Another objective of the present disclosure is to enable the oxygen supply unit to operate in conjunction with the ventilation unit for indoor/outdoor air ventilation or to operate independently, thereby implementing various functions.

Still another objective of the present disclosure is to allow nitrogen separated from the oxygen supply unit to be naturally discharged to the outside through the interconnection structure of the ventilation unit and the oxygen supply unit.

### Technical Solution

According to the features of the present disclosure for achieving the above-mentioned objectives, the ventilation device of the present disclosure may include a ventilation unit and an oxygen supply unit. The interior of the ventilation unit may be provided with an outdoor air intake path having an outdoor-air opening and a supply-air opening disposed on opposite ends thereof and an indoor air discharge path having a return-air opening and an exhaust-air opening disposed on opposite ends thereof. The oxygen supply unit may be internally provided with a compression module that compresses air and an adsorption module that adsorbs nitrogen from the air compressed by the compression module. A first delivery part may be provided between the ventilation unit and the oxygen supply unit to connect the outdoor air intake path to an internal path of the oxygen supply unit. A second delivery part may be provided between the ventilation unit and the oxygen supply unit to connect the indoor air discharge path to the internal path of the oxygen supply unit.

In addition, the first delivery part may deliver a portion of outdoor air flowing through the outdoor air intake path into the oxygen supply unit, or may deliver oxygen separated by the oxygen supply unit to the outdoor air intake path.

Furthermore, the first delivery part may be connected to the outdoor air intake path closer to the outdoor-air opening than to the supply-air opening.

In addition, the second delivery part may deliver nitrogen separated by the oxygen supply unit to the indoor air discharge path.

Furthermore, the ventilation unit may include a ventilation casing, an outdoor air intake fan disposed in the outdoor air intake path, and an indoor air discharge fan disposed in the indoor air discharge path. The oxygen supply unit may include an oxygen supply casing, the compression module that compresses air, and the adsorption module having an adsorption bed that adsorbs nitrogen from the air compressed by the compression module. In this case, the first delivery part and the second delivery part may be disposed between the ventilation casing and the oxygen supply casing. The oxygen supply unit and the supply-air opening may be connected to each other by an oxygen delivery pipe, and the oxygen supply unit may discharge oxygen separated through the adsorption module to the oxygen delivery pipe.

In addition, the oxygen supply unit and indoor spaces may be connected by an oxygen supply pipe, and the oxygen supply unit may discharge oxygen separated by the adsorption module into the oxygen supply pipe.

Furthermore, the oxygen supply pipe may branch into a plurality of oxygen branch pipes connected respectively to the plurality of indoor spaces partitioned from each other, and an oxygen valve may be disposed in each of some or all of the plurality of oxygen branch pipes.

In addition, the oxygen supply unit and the indoor spaces may be connected by an indoor air supply pipe independent of the oxygen supply pipe the oxygen supply pipe. The indoor air supply pipe may supply indoor air from each of the indoor spaces to the compression module through the indoor air supply pipe.

Furthermore, the indoor air supply pipe may branch into a plurality of indoor air branch pipes connected respectively to the plurality of indoor spaces partitioned from each other, and an indoor-air valve may be disposed in each of some or all of the plurality of indoor air branch pipes.

In addition, the supply-air opening and the indoors space may be connected by an outdoor air intake pipe, and the return-air opening and the indoor spaces may be connected by an indoor air discharge pipe independent of the outdoor air intake pipe. The oxygen supply pipe may form a path independent of a path of the outdoor air intake pipe.

Furthermore, a delivery fan may be disposed in the oxygen supply unit so as to face the first delivery part.

In addition, the delivery fan may rotate in a first direction to draw in outdoor air from the outdoor air intake path, or rotate in a second direction to discharge gas inside the oxygen supply unit to the outdoor air intake path.

Furthermore, the first delivery part and the second delivery part may be provided with a first delivery damper and a second delivery damper, respectively.

In addition, the ventilation unit may be provided with a ventilation damper that opens and closes the return-air opening, wherein the ventilation damper may be disposed between the second delivery part and the return-air opening.

Furthermore, the outdoor air intake pipe may branch into a plurality of outdoor air branch pipes connected respectively to the plurality of indoor spaces partitioned from each other, and an outdoor air intake damper may be disposed in each of some or all of the plurality of outdoor air branch pipes.

In addition, the ventilation method may first include determining, by a controller, oxygen concentration and carbon dioxide concentration of the indoor space, and temperature difference between the indoor space and an external space. Subsequently, on the basis of the oxygen concentration, the carbon dioxide concentration, and the temperature difference, the controller may perform one of a ventilation mode, a ventilation and oxygen supply mode, an outdoor air utilization oxygen supply mode, and an indoor air utilization oxygen supply mode for the indoor space.

In this case, in the ventilation mode, the oxygen supply unit may stop, and only the ventilation unit may operate to ventilate the indoor space. In the ventilation and oxygen Supply mode, the ventilation unit and the oxygen supply unit may operate simultaneously, so that the indoor space may be ventilated and oxygen may be supplied to the indoor space. In the outdoor air utilization oxygen supply mode, the supply-air opening may be closed, and the oxygen supply unit may separate oxygen from outdoor air introduced through the outdoor-air opening and supply the oxygen to the indoor space.

### Advantageous Effects

As described above, the ventilation device having an oxygen-supplying function and the ventilation method using the same according to the present disclosure may have the following effects.

In the present disclosure, the ventilation device may include the ventilation unit and the oxygen supply unit. The oxygen supply unit may be independently arranged and operates outside the ventilation unit but may be connected to the ventilation unit through the delivery part and thus may operate while sharing gases according to an operating mode. As described above, the oxygen supply unit may be independently located outside the ventilation unit, thereby simplifying the internal structure of the ventilation device.

Furthermore, the independent oxygen supply unit may be easily applied to an existing ventilation device, so the ventilation device of the present disclosure may have the advantages of ease of installation and high compatibility.

In addition, the oxygen supply unit constituting the ventilation device of the present disclosure may operate in conjunction with the ventilation unit or independently, providing various functions such as (i) a ventilation mode, (ii) a ventilation and oxygen supply mode, (iii) an outdoor air utilization oxygen supply mode, and (iv) an indoor air utilization oxygen supply mode. Therefore, the ventilation device of the present disclosure may implement various modes according to the conditions of the indoor space, thereby maintaining indoor space comfortable.

In particular, under conditions unfavorable for heat exchange during ventilation, such as extremely cold or hot weather, oxygen may be supplied to the indoor space by operating the oxygen supply unit without operating the ventilation unit, and air in the indoor space may be delivered to the oxygen supply unit to reduce carbon dioxide concentration. Therefore, regardless of the season, the indoor space may always be maintained in a comfortable state.

Furthermore, in the present disclosure, the ventilation unit and the oxygen supply unit may be connected by the delivery part, and the delivery part may discharge nitrogen separated by the oxygen supply unit to the ventilation unit. The ventilation unit may discharge the delivered nitrogen to the outside through the indoor air discharge path. Therefore, even without a separate exhaust device, the nitrogen generated during the oxygen production process may be smoothly discharged to the outside.

### DESCRIPTION OF DRAWINGS

FIG. 1 is a view illustrating a state in which a ventilation device having an oxygen-supplying function according to a first embodiment of the present disclosure is connected to an indoor space.

FIG. 2 is a perspective view showing the structure of the ventilation device according to the first embodiment of the present disclosure.

FIG. 3 is a perspective view showing a state in which a ventilation unit and an oxygen supply unit, which constitute the ventilation device according to the first embodiment of the present disclosure, are separated from each other.

FIG. 4 is a structural view showing the structure of the ventilation device having an oxygen-supplying function according to the first embodiment of the present disclosure.

FIG. 5 is a front view showing the configuration of the oxygen supply unit according to the first embodiment of the present disclosure.

FIG. 6 is a structural view showing a state in which a first space is ventilated and oxygen is separated from outdoor air and supplied to the first space according to the first embodiment of the present disclosure.

FIG. 7 is a structural view showing a state in which oxygen is separated from outdoor air and supplied to the first space according to the first embodiment of the present disclosure.

FIG. 8 is a structural view showing a state in which oxygen is separated from indoor air of the first space and supplied to the first space according to the first embodiment of the present disclosure.

FIG. 9 is a structural view showing a state in which the first space and a second space are ventilated, and oxygen is separated from outdoor air and supplied to the first space and the second space according to the first embodiment of the present disclosure.

FIG. 10 is a structural view showing a state in which oxygen is separated from outdoor air and supplied to the first space and the second space according to the first embodiment of the present disclosure.

FIG. 11 is a structural view showing a state in which oxygen is separated from indoor air of the first space and the second space, and supplied to the first space and the second space according to the first embodiment of the present disclosure.

FIG. 12 is a structural view showing the structure of the ventilation device having an oxygen-supplying function according to a second embodiment of the present disclosure.

FIG. 13 is a view showing a state in which the ventilation device of the second embodiment of FIG. 12 is connected to individual indoor spaces.

FIG. 14 is a structural view showing the structure of the ventilation device having an oxygen-supplying function according to a third embodiment of the present disclosure.

FIG. 15 is a structural view showing the structure of the ventilation device having an oxygen-supplying function illustrated in FIG. 13 according to a fourth embodiment.

FIG. 16 is a graph showing a process in which oxygen is generated by the oxygen supply unit according to the first embodiment of the present disclosure.

FIG. 17 is a graph showing changes in oxygen concentration in the first space and the second space when oxygen is supplied to the first space and the second space according to the first embodiment of the present disclosure.

### MODE FOR INVENTION

Hereinafter, some embodiments of the present disclosure will be described in detail with reference to exemplary drawings. It should be noted that, in assigning reference numerals to components in each drawing, the same reference numerals are used for the same components as much as possible, even if they are shown in different drawings. Furthermore, in describing the embodiments of the present disclosure, detailed descriptions of well-known components or functions are omitted when it is determined that such descriptions may obscure the understanding of the embodiments of the present disclosure.

The present disclosure relates to a ventilation device having an oxygen-supplying function (hereinafter referred to as “the ventilation device”). The ventilation device of the present disclosure may discharge the air of an indoor space to the outside and introduce the air of an outdoor space into the indoor space to ventilate the indoor space, and in this process, may increase energy efficiency through heat exchange. At the same time, the ventilation device of the present disclosure may supply oxygen to the indoor space to increase oxygen concentration in the indoor space. For this function, the ventilation device of the present disclosure may include a ventilation unit 10 and an oxygen supply unit 100. Hereinafter, the structure of the ventilation unit 10 and the oxygen supply unit 100 will be described, focusing on a connection structure thereof.

FIG. 1 illustrates a state in which a ventilation device having an oxygen-supplying function according to a first embodiment of the present disclosure is connected to an indoor space. As shown in FIG. 1, the ventilation unit 10 and the oxygen supply unit 100 may be disposed in a location independent of the indoor space. The ventilation unit 10 and the oxygen supply unit 100 may be disposed at a location at which air is introduced from the outside for ventilation of a building. For example, the ventilation unit 10 and the oxygen supply unit 100 may be installed on the ceiling (or wall) of a multipurpose room, balcony, outdoor unit room, etc. of the building.

The ventilation unit 10 and the oxygen supply unit 100 may be disposed to be adjacent to each other. In this embodiment, the ventilation unit 10 and the oxygen supply unit 100 may be arranged side by side, in a left-right configuration. The ventilation unit 10 and the oxygen supply unit 100 may be configured as separate devices having independent casings 11 and 101, respectively, and the casings may be connected by a first delivery part 110 and a second delivery part 120, which will be described below.

The ventilation unit 10 may introduce outdoor air and discharge indoor air. In this case, air supplied from the ventilation unit 10 to the indoor space may be defined as supply air (SA), air circulating within the indoor space and discharged to the ventilation unit 10 may be defined as return air (RA), air flowing into the ventilation unit 10 from the outside may be defined as outdoor air (OA), and air discharged from the ventilation unit 10 to the outside may be defined as exhaust air (EA).

The ventilation unit 10 may exchange heat between outdoor air and indoor air. The ventilation unit 10 may cool or heat air introduced from outside and supplied indoors. To this end, a heat exchanger 70, which will be described below, may be disposed in the ventilation unit 10.

As shown in FIG. 1, the ventilation unit 10 and the oxygen supply unit 100 may be connected to the indoor space. The indoor space may include a plurality of indoor spaces that are partitioned from one another. For example, the indoor space may include a first room R1, a second room R2, a corridor CR, and a living room LR. In FIG. 1, the arrows indicate directions in which air or oxygen is supplied to the plurality of indoor spaces and directions in which air is discharged from the indoor spaces.

The plurality of indoor spaces may be connected respectively to the ventilation unit 10 and the oxygen supply unit 100. The plurality of indoor spaces may be connected to the ventilation unit 10 by an outdoor air intake pipe 310. The outdoor air intake pipe 310 may branch into a plurality of outdoor air branch pipes 311, 313, 315, and 317 connected respectively to the plurality of indoor spaces partitioned from each other. The plurality of indoor spaces may be connected to the oxygen supply unit 100 by an oxygen supply pipe 350. The oxygen supply pipe 350 may branch into a plurality of oxygen branch pipes 351 and 353 connected respectively to the plurality of indoor spaces partitioned from each other. The outdoor air intake pipe 310 and the oxygen supply pipe 350 will be described again below.

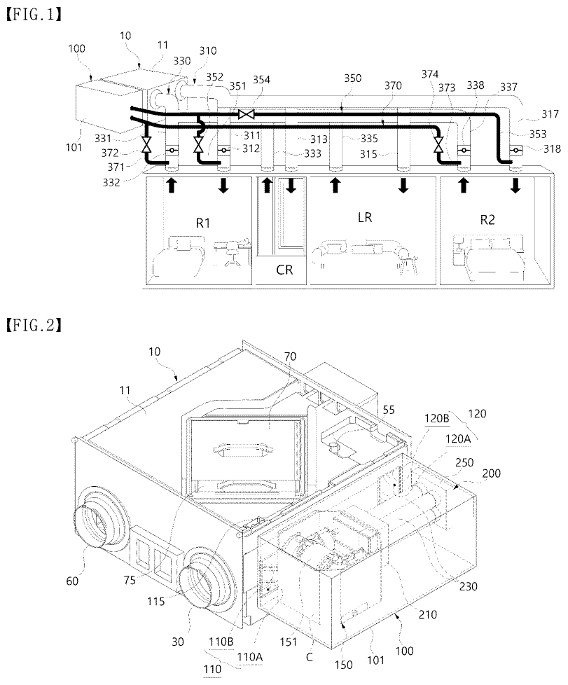

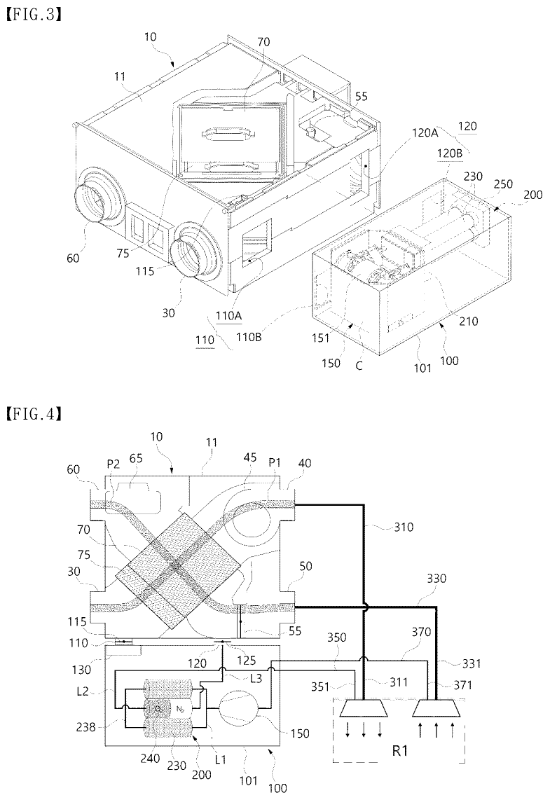

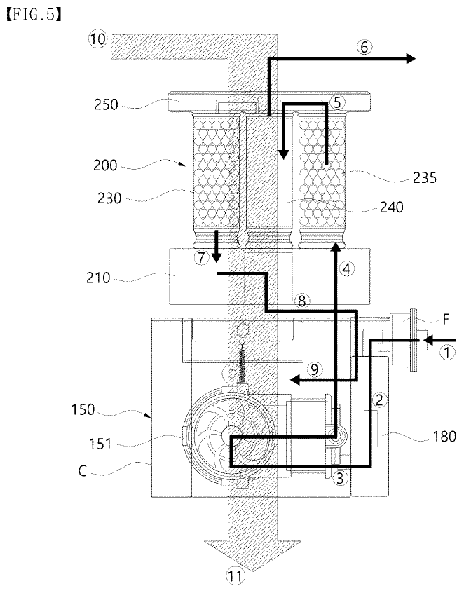

FIGS. 2 and 3 illustrate perspective views of the structure of the ventilation device having an oxygen-supplying function according to the first embodiment of the present disclosure. Furthermore, FIG. 4 illustrates a structural view of the ventilation device having an oxygen-supplying function according to the first embodiment of the present disclosure. Referring to these, the ventilation unit 10 and the oxygen supply unit 100 may have different casings 11 and 101, respectively, and be arranged side by side in the left-right direction. In another example, the ventilation unit 10 and the oxygen supply unit 100 may be stacked in a vertical direction. In another example, the ventilation unit 10 and the oxygen supply unit 100 may share a single casing, wherein a partition plate may be provided inside the casing to separate the ventilation unit 10 from the oxygen supply unit 100.

First, referring to the ventilation unit 10, the framework of the ventilation unit 10 may be constituted by a ventilation casing 11. The ventilation casing 11 may be provided with an outdoor-air opening 30, a supply-air opening 40, a return-air opening 50, and an exhaust-air opening 60, through which outdoor air, supply air, return air, and exhaust air, respectively, pass. The outdoor-air opening 30, the supply-air opening 40, the return-air opening 50, and the exhaust-air opening 60 may be open to the outside of the casing.

Referring to FIG. 4, an outdoor air intake path P1 may be formed between the outdoor-air opening 30 and the supply-air opening 40. The outdoor air intake path P1, which is a path through which outdoor air is drawn in from the outside and supplied to the indoor space, may be formed inside the ventilation unit 10.

An indoor air discharge path P2 may be formed between the return-air opening 50 and the exhaust-air opening 60. The indoor air discharge path P2, which is a path through which indoor air is drawn in from the indoor space and discharged to the outside, may be formed inside the ventilation unit 10.

An outdoor air intake fan 45 may be disposed at a position adjacent to the supply-air opening 40. The outdoor air intake fan 45 may generate suction force through rotation thereof. The outdoor air intake fan 45 may introduce fresh outdoor air through the outdoor-air opening 30 and discharge the air through the supply-air opening 40. The discharged outdoor air may flow along the outdoor air intake pipe 310 and then be supplied to the respective indoor spaces through the plurality of outdoor air branch pipes 311, 313, 315, and 317.

A ventilation damper 55 may be disposed in the ventilation unit 10. The ventilation damper 55 may open and close the return-air opening 50. The ventilation damper 55 may be disposed in the indoor air discharge path P2. In this embodiment, the ventilation damper 55 may be disposed between the second delivery part 120, which will be described below, and the return-air opening 50. Thus, even if the operation of the ventilation unit 10 is stopped, when the ventilation damper 55 is closed, gases such as nitrogen and carbon dioxide discharged from the oxygen supply unit 100 through the second delivery part 120 to the indoor air discharge path P2 may be discharged through the exhaust-air opening 60 without flowing back toward the indoor space through an indoor air discharge pipe 330.

An indoor air discharge fan 65 may be disposed in the indoor air discharge path P2. The indoor air discharge fan 65 may generate suction force through rotation thereof. The indoor air discharge fan 65 may draw contaminated indoor air through the return-air opening 50 and discharge the air through the exhaust-air opening 60. A plurality of discharge branch pipes 331, 333, 335, and 337 branched from the indoor air discharge pipe 330 may draw contaminated indoor air from the plurality of indoor spaces, and the indoor air passing through the indoor air discharge pipe 330 may be drawn into the indoor air discharge path P2 through the return-air opening 50 of the ventilation unit 10. In addition, the indoor air passing through the indoor air discharge path P2 may be discharged to the outside through the exhaust-air opening 60.

The heat exchanger 70 may be disposed between the outdoor air intake path P1 and the indoor air discharge path P2. The heat exchanger 70 may perform heat exchange between outdoor air being introduced and indoor air being discharged. The heat exchanger 70 may have a rectangular column shape. Furthermore, the heat exchanger 70 may be arranged such that a longitudinal cross-section thereof has a rhombus shape.

The heat exchanger 70 may have a structure of a cross-flow plate type. That is, the heat exchanger 70 may separate an outdoor air path and an indoor air path by a partition plate made of a specially processed paper. Accordingly, outdoor air and indoor air may pass through the heat exchanger 70 without mixing with each other. The heat exchanger 70 may be configured such that the indoor air and outdoor air, which typically have different temperatures, pass through different paths while these different paths are stacked. In addition, a surface where the two paths are stacked may be formed by the specially processed paper. Accordingly, the indoor air and the outdoor air may exchange heat through both moisture that exchanges latent heat and heat that exchanges sensible heat via a high-efficiency heat exchange membrane. Here, the specially processed paper used in the heat exchanger 70 may have the characteristic of allowing only heat and moisture to pass through, while blocking the passage of air.

The heat exchanger 70 may perform heat exchange between outdoor air and indoor air that are drawn into the ventilation casing 11. Accordingly, the outdoor air passing through the heat exchanger 70 may absorb heat from the indoor air while passing through the heat exchanger 70, and may then be supplied into the indoor space. As a result, even when the ventilation unit 10 operates during winter, the temperature of the indoor space may not drop abruptly.

The heat exchanger 70 may be provided with a filter 75. The filter 75 may filter out foreign substances contained in air flowing into the heat exchanger 70.

Next, the oxygen supply unit 100 will be described. The framework of the oxygen supply unit 100 may be constituted by an oxygen supply casing 101. The oxygen supply casing 101 may be disposed to be adjacent to the ventilation unit 10. A compression module 150 and an adsorption module 200, which will be described below, may be disposed inside the oxygen supply casing 101. Referring to FIG. 5, a module casing C may be added inside the oxygen supply casing 101 to surround the compression module 150. The module casing C may reduce operational noise generated by the compression module 150.

The oxygen supply casing 101 may be provided with the first delivery part 110. The first delivery part 110 may be disposed between the ventilation unit 10 and the oxygen supply unit 100. The first delivery part 110 may connect the outdoor air intake path P1 with the internal path of the oxygen supply unit 100. Through the first delivery part 110, all a portion of outdoor air may be introduced into the oxygen supply casing 101. As shown in FIG. 3, the first delivery part 110 may be divided into a first return air delivery part 110A disposed in the ventilation unit 10, and a first oxygen delivery part 110B disposed in the oxygen supply unit 100.

The outdoor air introduced in this manner may be compressed by the compression module 150 and then supplied to the adsorption module 200. Here, the internal path may include not only the internal space of the oxygen supply casing 101, but also a compressed air supply line L1, an oxygen supply line L2, and an exhaust line L3, which will be described below.

The first delivery part 110 may be connected to a portion of the outdoor air intake path P1 closer to the outdoor-air opening 30 than to the supply-air opening 40. Accordingly, at least a portion of air introduced through the outdoor-air opening 30 may be supplied into the oxygen supply unit 100 through the first delivery part 110.

The first delivery part 110 may include a first delivery damper 115 provided therein. The first delivery damper 115 may open and close the first delivery part 110. The first delivery damper 115 may open and close the first delivery part 110 by rotating through an electric motor. The first delivery damper 115 may be controlled by a controller (not shown).

The oxygen supply casing 101 may be provided with the second delivery part 120. The second delivery part 120 may be disposed between the ventilation unit 10 and the oxygen supply unit 100. The second delivery part 120 may connect the indoor air discharge path P2 with the internal path of the oxygen supply unit 100. Through the second delivery part 120, nitrogen separated by the oxygen supply unit 100 and carbon dioxide introduced from the indoor space may be delivered to the ventilation unit 10. The nitrogen and carbon dioxide delivered to the ventilation unit 10 may be discharged to the outside through the indoor air discharge path P2.

As shown in FIG. 3, the second delivery part 120 may be divided into a second return air delivery part 120A disposed in the ventilation unit 10 and a second oxygen delivery part 120B disposed in the oxygen supply unit 100.

The second delivery part 120 may include a second delivery damper 125 (see FIG. 4) provided therein. The second delivery damper 125 may open and close the second delivery part 120. The second delivery damper 125 may open and close the second delivery part 120 by rotating via an electric motor. The second delivery damper 125 may be controlled by the controller.

A delivery fan 130 may be disposed at a position adjacent to the first delivery part 110. The delivery fan 130 may function to draw in outdoor air through the first delivery part 110 or to discharge oxygen generated by the oxygen supply unit 100. The delivery fan 130 may be positioned to face the first delivery part 110.

The delivery fan 130 may (i) rotate in a first direction to draw in outdoor air from the outdoor air intake path P1, and (ii) rotate in a second direction to discharge gas inside the oxygen supply unit 100 to the outdoor air intake path P1. Here, the first direction refers to a direction in which the delivery fan 130 rotates to draw in outdoor air from the outdoor air intake path P1. The second direction refers to a direction in which the delivery fan 130 rotates to supply oxygen to the outdoor air intake path P1.

When the delivery fan 130 supplies oxygen to the outdoor air intake path P1, the oxygen, together with outdoor air introduced through the supply-air opening 40, may be supplied to the indoor space. More specifically, the oxygen, together with the outdoor air, may be supplied to the indoor space through the outdoor air intake pipe 310. In this case, the oxygen supply pipe 350 may be omitted.

Referring to FIGS. 4 and 5, the compression module 150 and the adsorption module 200 will be described. The compression module 150 may be disposed in the oxygen supply unit 100. The compression module 150 may draw in indoor air, compress the air, and then supply the compressed air to the adsorption module 200. To this end, the compression module 150 may include a compressor 151. The compressor 151 may compress air while rotating by using electrical energy. The compressor 151 may be of various types, such as a reciprocating compressor, a rotary compressor, or a turbo compressor.

The compression module 150 may include the module casing C. The module casing C may surround components including the compressor 151. The module casing C may reduce the transmission of noise generated during the operation of the compression module 150 to the outside.

Although not shown, a soundproofing material may be provided on the inner surface of the module casing C. The soundproofing material may reduce the extent to which noise generated from the compression module 150 leaks to the outside. The soundproofing material may be made of sponge, synthetic fiber, wood fiber, etc. The soundproofing material may be thinly attached to the inner surface of the module casing C.

Inside the module casing C, not only the compressor 151 constituting the compression module 150 but also a muffler 180 may be arranged. The muffler 180 may reduce noise generated during the air intake process of the compressor 151 and noise generated during the discharge of nitrogen. The module casing C may surround the muffler 180 to doubly reduce noise. Of course, since a unit casing 101 is disposed outside the module casing C, the unit casing 101 may also serve to reduce noise.

An intake filter F may be disposed in the muffler 180. The intake filter F may be disposed on a side surface of the module casing C. Accordingly, air introduced into the oxygen supply unit 100 may first pass through the intake filter F and then be introduced into the interior of the module casing C, more specifically, into the interior of the muffler 180, which will be described below.

The compressor 151 may compress indoor air and supplies the compressed air to the adsorption module 200. Although not shown, an external power may be supplied to the compressor 151, and a wire harness or connector for controlling the compressor 151 may be connected thereto. The compressor 151 may be arranged in the left-right direction. That is, the compressor 151 may be disposed inside the module casing C in a lying orientation.

Referring to the adsorption module 200, the adsorption module 200 may produce high-concentration oxygen by using air compressed by the compressor 151. In this embodiment, the adsorption module 200 may be configured as a PSA filter. The PSA filter, which uses an oxygen concentrator utilizing pressure swing adsorption, only uses compressed air and an adsorbent, thereby having the advantages of no emission of pollutants and ease of use. In this embodiment, the adsorption module 200 may be disposed above the compression module 150, and may include a plurality of adsorption beds 235 which are arranged in a circular shape and adsorb nitrogen from air compressed by the compression module 150.

The adsorption module 200 may include a lower block 210, an upper block 250, and the plurality of adsorption beds 235 disposed therebetween. Although not shown, the lower block 210 and the upper block 250 may each include a port structure therein for distributing gas. For example, a plurality of intake ports may be arranged inside the lower block 210, and a plurality of exhaust ports may be arranged inside the upper block 250. The intake ports may distribute the compressed air, and the exhaust ports may distribute the oxygen separated from the adsorption beds 235.

The plurality of adsorption beds 235 may be disposed between the lower block 210 and the upper block 250. In addition, the plurality of adsorption beds 235 may be arranged in a circular shape. The adsorption beds 235 arranged in a circular shape may reduce an installation area occupied by the air purifier. Furthermore, the plurality of adsorption beds 235 may continuously generate oxygen without interruption through continuous operation.

Inside the upper block 250, an orifice 238 (see FIG. 4) may be formed to connect paths to each other that connect the plurality of adsorption beds 235 and an oxygen tank 240 to each other. The orifice 238 may supply a portion of oxygen discharged from one of the adsorption beds 235 to a remaining adsorption bed 235 in order to assist with the discharge of the nitrogen during the desorption process of the nitrogen. For example, the controller may control the opening degree of the orifice 238 so that time which it takes for the concentration of oxygen measured by an oxygen sensor, which serves as an oxygen concentration detection part, to decrease to a reference oxygen concentration is equal to time which it takes for the concentration of nitrogen measured by a nitrogen sensor, which serves as a nitrogen concentration detection part, to decrease to a reference nitrogen concentration.

The oxygen tank 240, which stores oxygen discharged from the plurality of adsorption beds 235, may be disposed at the center of the plurality of adsorption beds 235. The oxygen tank 240 may store generated high-concentration oxygen and may supply the oxygen to the indoor space under the control of the controller.

FIG. 5 schematically illustrates a process in which the oxygen supply unit 100 generates and supplies oxygen. First, when the compressor 151 operates, the indoor air may be drawn in. The drawn-in indoor air may flow into the muffler 180 through the intake filter F (the direction of arrow \textcircled{1}). The indoor air that has passed through the muffler 180 (the direction of arrow \textcircled{2}) may then be introduced into the compressor 151 (the direction of arrow \textcircled{3}).

The indoor air compressed by the compressor 151 may be delivered to the adsorption module 200 (the direction of arrow \textcircled{4}). The adsorption module 200 may adsorb nitrogen and discharge oxygen through an adsorption-blow-down-desorption process (see FIG. 16). The discharged oxygen may be delivered to the oxygen tank 240 (the direction of arrow \textcircled{5}). In addition, the oxygen tank 240 may supply the stored oxygen toward the indoor space (the direction of arrow \textcircled{6}).

Meanwhile, nitrogen desorbed from the adsorption module 200 may be delivered to the lower block 210 (the direction of arrow \textcircled{7}). Additionally, the nitrogen passing through the lower block 210 may be discharged into the interior of the module casing C (the directions of arrows \textcircled{8} and \textcircled{9}). When the delivery fan 130 rotates in the first direction, outdoor air may be drawn in through the first delivery part 110 (the direction of arrow \textcircled{10}). In this case, the outdoor air may become cooling air. The drawn-in outdoor air may move downward to cool the compressor 151. In addition, the outdoor air may be discharged downward (the direction of arrow \textcircled{11}) together with the nitrogen inside the module casing C.

Referring to FIG. 4, indoor air drawn into the compressor 151 through the intake filter F may be compressed and then distributed to the intake ports (not shown) formed inside the lower block 210. The air passing through the intake ports may pass through an inlet valve (not shown) and be delivered to the adsorption module 200 via the compressed air supply line L1.

Compressed air delivered to the adsorption beds 235 through the compressed air supply line L1 may have nitrogen separated and high-concentration oxygen generated as the compressed air passes through the adsorption beds 230. The generated oxygen may be stored in the oxygen tank 240 and then supplied to the indoor space through the oxygen supply line L2. The oxygen supply line L2 may be connected to the oxygen supply pipe 350. The oxygen supply line L2 may be considered as a part of the oxygen supply pipe 350.

Meanwhile, nitrogen separated from the adsorption module 200 may be discharged through a separate exhaust line L3. The exhaust line L3 may be connected to the second delivery part 120. The exhaust line L3 may direct the generated nitrogen to the second delivery part 120, and the nitrogen may be discharged to the indoor air discharge path P2 through the second delivery part 120.

In another example, the exhaust line L3 may not be connected to the second delivery part 120 but may instead be open to the inside of the oxygen supply casing 101. In this case, nitrogen discharged into the interior of the oxygen supply casing 101 through the exhaust line L3 may flow into the indoor air discharge path P2 due to pressure difference between the indoor air discharge path P2 and the oxygen supply unit 100.

Referring back to FIGS. 1 and 4, the indoor space and the ventilation unit 10 may be connected by the outdoor air intake pipe 310 and the indoor air discharge pipe 330. The outdoor air intake pipe 310 and the indoor air discharge pipe 330 may form independent flow paths. Fresh outdoor air may flow through the supply-air opening via the outdoor air intake pipe 310. Contaminated indoor air from the indoor space may flow through the indoor air discharge pipe 330.

The plurality of outdoor air branch pipes 311, 313, 315, and 317 may branch from the outdoor air intake pipe 310. The outdoor air branch pipes 311, 313, 315, and 317 may be open toward the plurality of indoor spaces. Outdoor air intake dampers 312 and 318 may be disposed in some or all of the plurality of outdoor air branch pipes 311, 313, 315, and 317. The outdoor air intake dampers 312 and 318 may be opened and closed to selectively supply outdoor air to the plurality of indoor spaces. Referring to FIG. 1, the first outdoor air branch pipe 311 and the fourth outdoor air branch pipe 317, which are connected to the first room R1 and the second room R2, respectively, may be provided with the outdoor air intake dampers 312 and 318, respectively. In another example, the second outdoor air branch pipe 313 and the third outdoor air branch pipe 315, which are connected to the corridor CR and the living room LR, respectively, may also be provided with the outdoor air intake dampers 312 and 318, respectively.

The plurality of discharge branch pipes 331, 333, 335, and 337 may branch from the indoor air discharge pipe 330. The discharge branch pipes 331, 333, 335, and 337 may be open toward the plurality of indoor spaces. Indoor air discharge dampers 332 and 338 may be disposed in some or all of the plurality of discharge branch pipes 331, 333, 335, and 337. The indoor air discharge dampers 332 and 338 may be opened and closed to selectively discharge indoor air from the plurality of indoor spaces. Referring to FIG. 1, the first discharge branch pipe 331 and the fourth discharge branch pipe 337, which are connected to the first room R1 and the second room R2, respectively, may be provided with the indoor air discharge dampers 332 and 338, respectively. In another example, the second discharge branch pipe 333 and the third discharge branch pipe 335, which are connected to the corridor CR and the living room LR, respectively, may also be provided with the indoor air discharge dampers 332 and 338, respectively.

Meanwhile, the oxygen supply unit 100 and the indoor spaces may be connected by the oxygen supply pipe 350 and an indoor air supply pipe 370. The oxygen supply pipe 350 and the indoor air supply pipe 370 may form independent flow paths. High-concentration oxygen generated by the oxygen supply unit 100 may flow through the oxygen supply pipe 350. Contaminated indoor air from the indoor space may flow through the indoor air supply pipe 370. The oxygen supply unit 100 may adsorb and separate carbon dioxide and nitrogen from the contaminated indoor air, and separate/generate oxygen.

As shown in FIG. 1, the oxygen supply pipe 350 may branch into the plurality of oxygen branch pipes 351 and 353 connected respectively to the plurality of indoor spaces partitioned from each other. An oxygen valve may be disposed in each of some or all of the plurality of oxygen branch pipes 351 and 353. The oxygen valve may selectively supply oxygen to some of the plurality of indoor spaces. Referring to FIG. 1, among the plurality of oxygen branch pipes 351 and 353, a first oxygen branch pipe 351 and a second oxygen branch pipe 353 may be respectively connected to the first room R1 and the second room R2, and a first oxygen valve 352 may be provided in the first oxygen branch pipe 351. As another example, the oxygen supply pipe 350 may be connected to the corridor CR and the living room LR, and the oxygen valve may be disposed therein.

The indoor air supply pipe 370 may branch into a plurality of indoor air branch pipes 371 and 373 connected respectively to the plurality of indoor spaces partitioned from each other. Indoor-air valves 372 and 374 may be disposed in some or all of the plurality of indoor air branch pipes 371 and 373. The indoor-air valves 372 and 374 may draw in indoor air from some of the plurality of indoor spaces and deliver the indoor air to the oxygen supply unit 100. Referring to FIG. 1, the first indoor air supply pipe 370 and the second indoor air supply pipe 370 of the plurality of indoor air supply pipes 370 may be connected to the first room R1 and the second room R2, respectively, and the first indoor air supply pipe 370 may be provided with a first indoor-air valve 372. The second indoor air supply pipe 370 may be provided with a second indoor-air valve 374. In another example, the indoor air supply pipe 370 may be even to the corridor CR and the living room LR.

Next, the process of controlling the indoor space according to the present disclosure will be described. First, the controller may determine oxygen concentration and carbon dioxide concentration in the indoor space, and temperature difference between the indoor space and the outdoor space. The oxygen concentration, carbon dioxide concentration, and temperature difference may be measured by sensor units (not shown) disposed in the plurality of indoor spaces and an outdoor temperature sensor (not shown) disposed outside. The controller may compare the measured oxygen concentration, carbon dioxide concentration, and temperature difference between the indoor and outdoor spaces with preset values, and operate the ventilation unit 10 or the oxygen supply unit 100.

For example, the controller may determine the environment of the first room R1, and if (i) the oxygen concentration is lower than a preset value, (ii) the carbon dioxide concentration is higher than a preset first reference value K1, and (iii) the temperature difference between the indoor and outdoor spaces is smaller than a preset value, the controller may determine that both oxygen supply and ventilation are required for the first room R1. When the temperature difference between the indoor and outdoor spaces is greater than the preset value, heat efficiency during ventilation may decrease, so the controller needs to determine this temperature difference.

In this case, the controller may operate the ventilation and oxygen supply mode for the first room R1. The ventilation and oxygen supply mode refers to a control method in which the first room R1 is ventilated and oxygen is simultaneously separated from outdoor air and supplied. To this end, the controller may operate both the ventilation unit 10 and the oxygen supply unit 100.

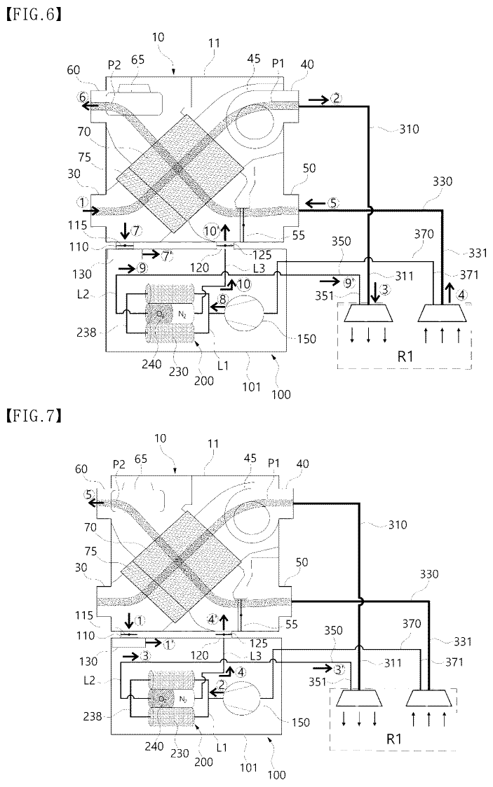

Referring to FIG. 6, the operation of the ventilation and oxygen supply mode in the first room R1 is illustrated. First, when the outdoor air intake fan 45 of the ventilation unit 10 operates, outdoor air may be drawn in through the outdoor-air opening 30 (the direction of arrow \textcircled{1}). The drawn-in outdoor air may flow along the outdoor air intake path P1, pass through the heat exchanger 70, and be discharged through the supply-air opening 40 (the direction of arrow \textcircled{2}). The discharged outdoor air may move along the outdoor air intake pipe 310 and then be supplied to the first room R1 through the first outdoor air branch pipe 311 (the direction of arrow \textcircled{3}).

In addition, when the indoor air discharge fan 65 of the ventilation unit 10 operates, indoor air from the first room R1 may be drawn in through the first discharge branch pipe 331 (the direction of arrow \textcircled{4}) and then flow along the indoor air discharge pipe 330. The indoor air flowing along the indoor air discharge pipe 330 may enter the indoor air discharge path P2 through the return-air opening 50 of the ventilation unit 10 (the direction of arrow \textcircled{5}).

The indoor air that has entered the indoor air discharge path P2 may exchange heat with the outdoor air while passing through the heat exchanger 70. The heat-exchanged indoor air may be discharged to the outside through the exhaust-air opening 60 (the direction of arrow \textcircled{6}).

Meanwhile, when the delivery fan 130 of the oxygen supply unit 100 operates, a portion of the outdoor air in the outdoor air intake path P1 may be drawn into the oxygen supply unit 100 through the first delivery part 110 by the delivery fan 130 (the direction of arrow \textcircled{7}). The drawn-in outdoor air may be discharged into the oxygen supply casing 101 (the direction of arrow \textcircled{7}′). The outdoor air discharged into the oxygen supply casing 101 may be delivered to the compression module 150 and compressed.

The outdoor air compressed by the compression module 150 may be supplied to the adsorption module 200 (the direction of arrow \textcircled{8}). While the air passes through the adsorption module 200, nitrogen may be adsorbed, and the separated oxygen may be stored in the oxygen tank. The oxygen in the oxygen tank may be delivered to the oxygen supply pipe 350 through the oxygen supply line L2 (the direction of arrow \textcircled{9}). The oxygen supply pipe 350 may deliver the supplied oxygen to the first oxygen branch pipe 351. Finally, the first oxygen branch pipe 351 may supply the delivered oxygen to the first room R1 (the direction of arrow \textcircled{9}′).

In addition, the nitrogen separated in the adsorption module 200 may flow along the exhaust line L3 (the direction of arrow 10). The nitrogen flowing along the exhaust line L3 may enter the indoor air discharge path P2 through the second delivery part 120 (the direction of arrow \textcircled{10}′). In this case, the second delivery damper 125 and the ventilation damper 55 may be opened, and the indoor air discharge fan 65 may operate. Since the ventilation damper 55 is open, the nitrogen may pass through the ventilation damper 55 and mix with the indoor air flowing toward the exhaust-air opening 60 to be discharged to the outside together (the direction of arrow \textcircled{6}).

In another example, when the controller determines the environment of the first room R1, and if (i) the oxygen concentration is lower than the preset first reference value K1, (ii) the carbon dioxide concentration is higher than a preset value, and (iii) the temperature difference between the indoor and outdoor spaces is greater than a preset value, the controller may determine that only ventilation and oxygen supply are required for the first room R1. When the temperature difference between the indoor and outdoor spaces is greater than the preset value, heat efficiency may decrease during ventilation, so the controller may omit ventilation and supply only oxygen to the first room R1.

In this case, the controller may operate the outdoor air utilization oxygen supply mode for the first room R1. The outdoor air utilization oxygen supply mode refers to a control method in which oxygen is supplied to the first room R1 by separating the oxygen from outdoor air. To this end, the controller may operate the entire oxygen supply unit 100, and in the ventilation unit 10, may operate the indoor air discharge fan 65 and open the ventilation damper 55. The controller may not operate the outdoor air intake fan 45 of the ventilation unit 10. In this case, the first room R1 may receive only oxygen without being ventilated.

Specifically, as shown in FIG. 7, when the delivery fan 130 of the oxygen supply unit 100 operates, outdoor air is introduced through the outdoor-air opening 30 to the initial section of the outdoor air intake path P1, and the outdoor air may be introduced into the oxygen supply unit 100 through the first delivery part 110 (the direction of arrow \textcircled{1}). The introduced outdoor air may be discharged into the interior of the oxygen supply casing 101 (the direction of arrow \textcircled{1}′). The outdoor air discharged into the interior of the oxygen supply casing 101 may be delivered to the compression module 150 and compressed.

The outdoor air compressed by the compression module 150 may be supplied to the adsorption module 200 (the direction of arrow \textcircled{2}). While the air passes through the adsorption module 200, nitrogen may be adsorbed, and the separated oxygen may be stored in the oxygen tank. The oxygen in the oxygen tank may be delivered to the oxygen supply pipe 350 through the oxygen supply line L2 (the direction of arrow \textcircled{3}), and the oxygen supply pipe 350 may deliver the supplied oxygen to the first oxygen branch pipe 351. Finally, the first oxygen branch pipe 351 may supply the delivered oxygen to the first room R1 (the direction of arrow \textcircled{3}′).

In addition, the nitrogen separated in the adsorption module 200 may flow along the exhaust line L3 (the direction of arrow \textcircled{4}). The nitrogen that has flowed along the exhaust line L3 may enter the indoor air discharge path P2 through the second delivery part 120 (the direction of arrow 4′). In this case, the ventilation damper 55 may be closed, and the indoor air discharge fan 65 may be operated. Accordingly, the nitrogen may be blocked by the ventilation damper 55 and may not flow back toward the first room R1, but may be drawn in by the indoor air discharge fan 65 and flow along the indoor air discharge path P2. Finally, the nitrogen may be discharged to the outside through the exhaust-air opening 60 (the direction of arrow \textcircled{5}).

Meanwhile, the controller may determine the environment of the first room R1 and, if (i) the oxygen concentration is lower than a preset value, (ii) the carbon dioxide concentration is higher than a preset second reference value K2, and (iii) the temperature difference between the indoor and outdoor spaces is smaller than a preset value, the controller may determine that both oxygen supply and ventilation are required for the first room R1. In this case, the second reference value K2 may be greater than the first reference value K1, so the carbon dioxide concentration in the first room R1 may be considered very high.

In this case, the controller may perform the indoor air utilization oxygen supply mode. The indoor air utilization oxygen supply mode refers to a control method in which the first room R1 is ventilated and oxygen is simultaneously supplied, wherein the oxygen is separated from the indoor air in the indoor space and supplied. To this end, the controller may operate both the ventilation unit 10 and the oxygen supply unit 100.

Referring to FIG. 8, the operation of the indoor air utilization oxygen supply mode in the first room R1 is illustrated. First, when the outdoor air intake fan 45 of the ventilation unit 10 operates, outdoor air may be drawn in through the outdoor-air opening 30 (the direction of arrow \textcircled{1}). The drawn-in outdoor air may flow along the outdoor air intake path P1, pass through the heat exchanger 70, and be discharged through the supply-air opening 40 (the direction of arrow \textcircled{2}). The discharged outdoor air may move along the outdoor air intake pipe 310 and then be supplied to the first room R1 through the first outdoor air branch pipe 311 (the direction of arrow \textcircled{3}).

In this case, since the ventilation damper 55 is closed, the indoor air from the first room R1 may not be drawn into the indoor air discharge path P2. However, since the indoor air discharge fan 65 is operating and the second delivery damper 125 is opened, the indoor air from the first room R1 may be drawn in through a first indoor air branch pipe 371 and then flow along the indoor air supply pipe 370 (the direction of arrow \textcircled{4}).

The contaminated indoor air flowing along the indoor air supply pipe 370 may be introduced into the oxygen supply unit 100 and then supplied to the compression module 150 (the direction of arrow \textcircled{5}). The air compressed by the compression module 150 may be supplied to the adsorption module 200 (the direction of arrow \textcircled{6}). While the air passes through the adsorption module 200, nitrogen may be adsorbed, and the separated oxygen may be stored in the oxygen tank. The oxygen from the oxygen tank may be delivered to the oxygen supply pipe 350 through the oxygen supply line L2 (the direction of arrow \textcircled{7}), and the oxygen supply pipe 350 may deliver the supplied oxygen to the first oxygen branch pipe 351. Finally, the first oxygen branch pipe 351 may supply the delivered oxygen to the first room R1 (the direction of arrow \textcircled{7}′).

In addition, the nitrogen separated in the adsorption module 200 may flow along the exhaust line L3 (the direction of arrow \textcircled{8}). The nitrogen flowing along the exhaust line L3 may enter the indoor air discharge path P2 through the first delivery part 110 (the direction of arrow \textcircled{9}). In this case, the ventilation damper 55 may be closed, and the indoor air discharge fan 65 may be operated. Accordingly, the nitrogen may be blocked by the ventilation damper 55 and may not flow back toward the first room R1, but may be drawn in by the indoor air discharge fan 65 and flow along the indoor air discharge path P2. Finally, the nitrogen may be discharged to the outside through the outdoor-air opening 30 (the direction of arrow \textcircled{10}).

In this case, a portion of outdoor air may be supplied to the oxygen supply unit 100 through the first delivery part 110 (the direction of arrow \textcircled{1}′). This outdoor air may be used to cool the compressor 151. Of course, a portion of the outdoor air may be compressed by the compression module 150. In another example, the first delivery part 110 may be blocked by the first delivery damper 115, and the indoor air may be supplied into the oxygen supply unit 100 only through the indoor air supply pipe 370.

In this indoor air utilization oxygen supply mode, the indoor air of the first room R1 may be supplied to the oxygen supply unit 100, where oxygen is separated, and then supplied back to the first room R1. Through this process, the concentration of carbon dioxide in the first room R1 may be significantly reduced. Accordingly, even if the carbon dioxide concentration in the first room R1 is higher than the preset second reference value K2, the carbon dioxide concentration in the first room R1 may be reduced to the first reference value K1 or lower through the indoor air utilization oxygen supply mode.

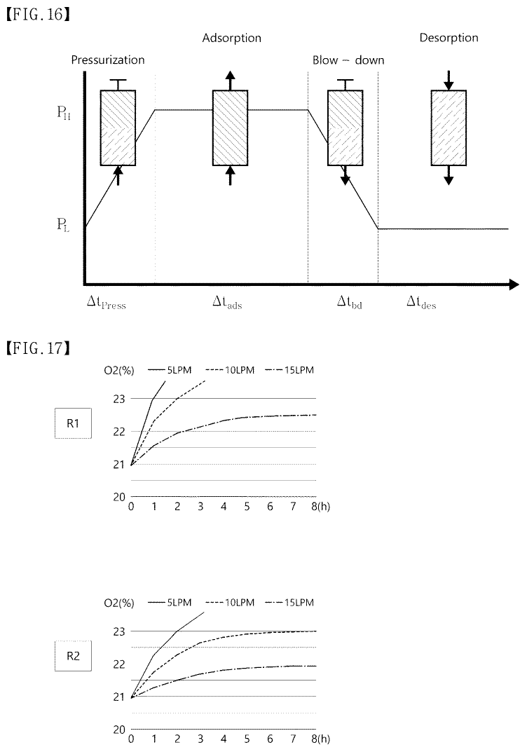

FIG. 17 illustrates change in oxygen concentration in the first room R1 and the second room R2 when the first room R1 and the second room R2 are controlled by using the indoor air utilization oxygen supply mode. As shown in the drawing, the oxygen supply flow rate per minute (LPM, Liter per minute) can be increased by using the indoor air utilization oxygen supply mode. Accordingly, the carbon dioxide concentration in the first room R1 and the second room R2 may be rapidly reduced through the indoor air utilization oxygen supply mode.

Furthermore, the controller may determine the environment of the first room R1, and if (i) the oxygen concentration is higher than the preset value, (ii) the carbon dioxide concentration is higher than the preset first reference value K1, and (iii) the temperature difference between the indoor and outdoor spaces is smaller than a preset value, the controller may determine that only ventilation is required for the first room R1. That is, oxygen supply to the first room R1 may not be necessary, and in this case, the ventilation mode may be selected. Here, the ventilation mode refers to a control method in which oxygen is not supplied by the oxygen supply unit 100, and only ventilation is performed.

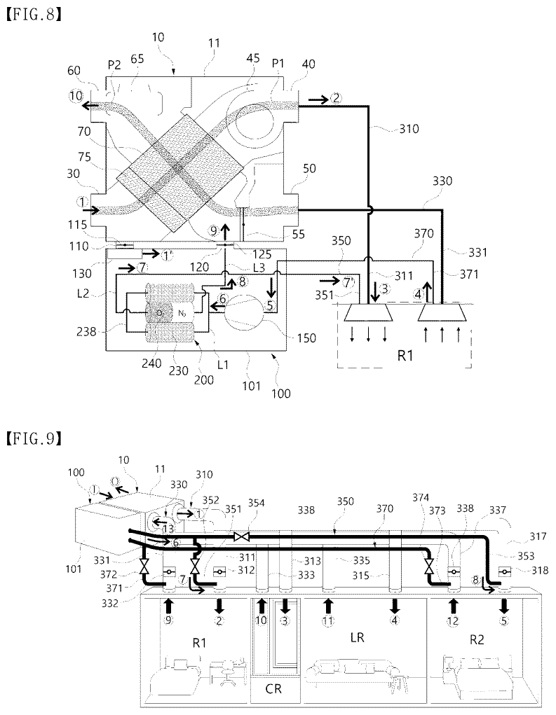

Meanwhile, FIG. 9 illustrates the states f the plurality of indoor spaces during the ventilation and oxygen supply mode. As shown in the drawing, when outdoor air is introduced from the outside (I), the introduced outdoor air may pass through the ventilation unit 10 and move along the outdoor air intake pipe 310 (the direction of arrow \textcircled{1}). In addition, the outdoor air flowing through the outdoor air intake pipe 310 may be supplied respectively to the first room R1, the corridor CR, the living room LR, and the second room R2 (the directions of arrows \textcircled{2}, \textcircled{3}, \textcircled{4}, and \textcircled{5}).

In addition, oxygen generated in the oxygen supply unit 100 may flow through the oxygen supply pipe 350 (the direction of arrow \textcircled{6}). The air flowing along the oxygen supply pipe 350 may be supplied respectively to the first room R1 and the second room R2 (the directions of arrows \textcircled{7} and \textcircled{8}).

The contaminated indoor air from the first room R1, the corridor CR, the living room LR, and the second room R2 may be discharged to the outside through the indoor air discharge pipe 330 (the directions of arrows \textcircled{9}, \textcircled{10}, \textcircled{11}, and \textcircled{12}). The discharged indoor air may flow into the ventilation unit 10 (the direction of arrow \textcircled{13}) and may be discharged to the outside through the exhaust-air opening 60 (O).

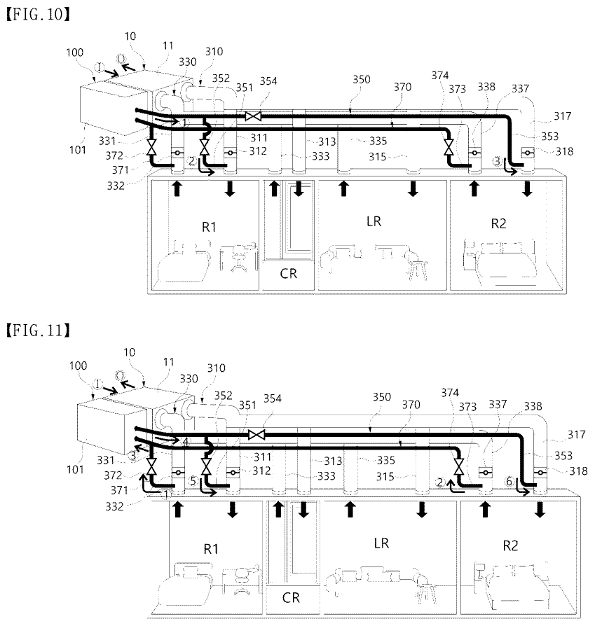

FIG. 10 illustrates the states of the plurality of indoor spaces during the outdoor air utilization oxygen supply mode. As shown in the drawing, when outdoor air is introduced from the outside (I), the introduced outdoor air may not be supplied to the first room R1, the corridor CR, the living room LR, and the second room R2 through the ventilation unit 10. The introduced air may be supplied to the oxygen supply unit 100.

The outdoor air supplied to the oxygen supply unit 100 may have oxygen separated by the oxygen supply unit 100, and the separated oxygen may be supplied to the first room R1 and the second room R2, respectively (the directions of arrows \textcircled{2}, \textcircled{3}). In addition, nitrogen separated in the oxygen supply unit 100 may be delivered to the ventilation unit 10, flow through the indoor air discharge path P2, and be discharged to the outside through the exhaust-air opening 60 (O).

FIG. 11 illustrates the states of the plurality of indoor spaces during the indoor air utilization oxygen supply mode. As shown in the drawing, first, the contaminated indoor air from the first room R1 and the second room R2 may be drawn in through the indoor air supply pipe 370 (the directions of arrows \textcircled{1}, \textcircled{2}). The drawn-in indoor air may be introduced into the oxygen supply unit 100 (the direction of arrow \textcircled{3}). After nitrogen is adsorbed and separated by the oxygen supply unit 100, the introduced indoor air may be delivered to the ventilation unit 10, flow through the indoor air discharge path P2, and be discharged to the outside through the exhaust-air opening 60 (O).

In addition, the high-concentration oxygen separated by the oxygen supply unit 100 may be supplied again to the first room R1 and the second room R2. The oxygen discharged from the oxygen supply unit 100 may flow through the oxygen supply pipe 350 (the direction of arrow \textcircled{4}). The oxygen may pass through the oxygen supply pipe 350, branch into the first oxygen branch pipe 351 and the second oxygen branch pipe 353, and then be supplied to the first room R1 and the second room R2 (the direction of arrows \textcircled{5} and \textcircled{6}).

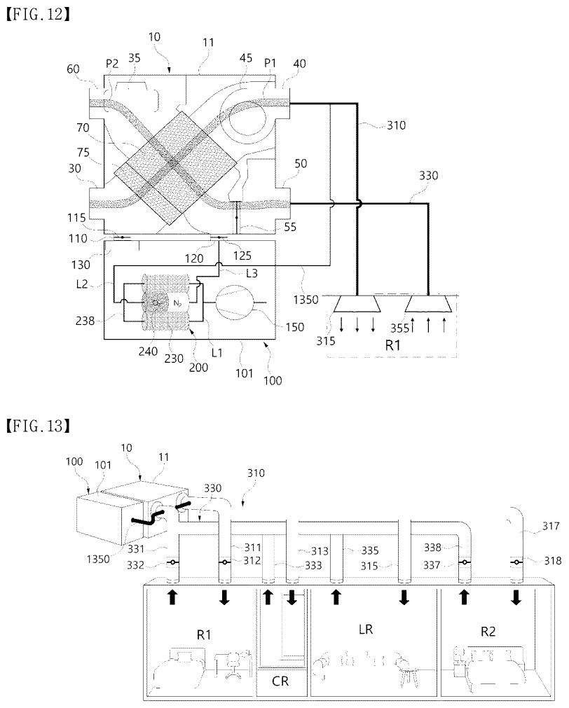

FIGS. 12 and 13 illustrate a second embodiment of a ventilation device according to the present disclosure. Only differences from the previous embodiment will be described. In this embodiment, the oxygen supply unit 100 and the supply-air opening 40 may be connected to each other by an oxygen delivery pipe 1350. The oxygen supply unit 100 may discharge oxygen separated through the adsorption module 200 to the oxygen delivery pipe 1350. That is, in this embodiment, the separate oxygen supply pipe 350 may be omitted. The oxygen supply unit 100 may deliver the generated oxygen to the outdoor air intake pipe 310 through the oxygen delivery pipe 1350, and may supply the oxygen to the indoor space by using the outdoor air intake pipe 310. In FIGS. 12 and 13, the oxygen delivery pipe 1350 is illustrated as being exposed outside the oxygen supply unit 100. However, alternatively, the oxygen delivery pipe 1350 may extend from the interior of the oxygen supply unit 100 to the interior of the ventilation unit 10.

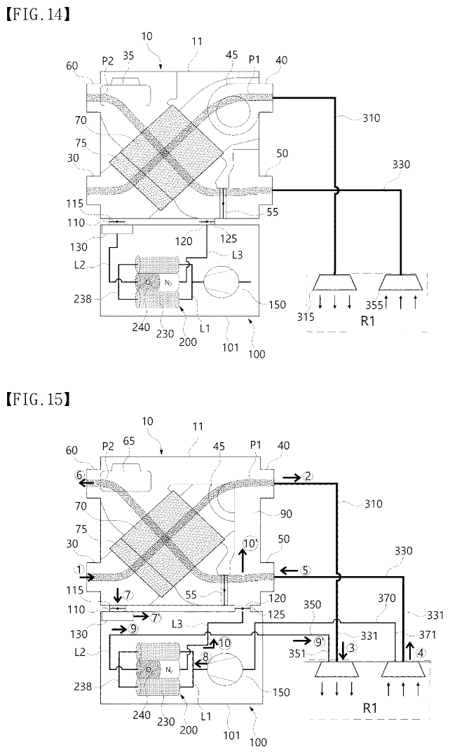

FIG. 14 illustrates a third embodiment of a ventilation device according to the present disclosure. Only differences from the previous embodiments will be described. In this embodiment, a separate oxygen supply pipe 350 and a separate indoor air supply pipe 370 are not connected to the oxygen supply unit 100, but the oxygen supply unit 100 may be connected only to the ventilation unit 10 through the first delivery part 110 and the second delivery part 120.

In this case, oxygen generated in the oxygen supply unit 100 may be delivered to the outdoor air intake path P1 through the first delivery part 110, mixed with introduced outdoor air, and then supplied to the indoor space. In addition, nitrogen separated in the oxygen supply unit 100 may be delivered to the indoor air discharge path P2 through the second delivery part 120, mixed with discharged return air, and then discharged to the outside through the exhaust-air opening 60.

FIG. 15 illustrates a fourth embodiment of a ventilation device according to the present disclosure. Only differences from the previous embodiments will be described. In this embodiment, the ventilation unit 10 may include a bypass path 90 disposed therein. The bypass path 90 may connect the oxygen supply unit 100 to the exhaust-air opening 60. More specifically, a first end portion of the bypass path 90 may be connected to the second delivery part 120, and a second end portion thereof may be connected to the exhaust-air opening 60. Accordingly, nitrogen discharged from the adsorption module 200 may be discharged directly to the exhaust-air opening 60 through the bypass path 90 without passing through the indoor air discharge path P2.

In addition, in the fourth embodiment shown in FIG. 15, the second delivery part 120 may be disposed closer to the return-air opening 50 than the ventilation damper 55. Accordingly, the nitrogen may be discharged to the outside through the exhaust-air opening 60 after passing through the second delivery part 120 and the bypass path 90 without passing through the ventilation damper 55. This flow is indicated by arrow \textcircled{10}′ in FIG. 15.

The above descriptions are merely illustrative of the technical spirit of the present disclosure, and various modifications and alterations may be made without departing from the essential characteristics of the present disclosure by those skilled in the art to which the present disclosure pertains. Accordingly, the embodiments disclosed in the present disclosure are intended to illustrate, not to limit, the technical spirit of the present disclosure, and the scope of the technical spirit of the present disclosure is not limited by these embodiments. The scope of protection of the present disclosure should be interpreted on the basis of the following claims, and all technical ideas falling within the equivalent scope thereof should be construed as being included in the scope of rights of the present disclosure.

1. A ventilation device having an oxygen-supplying function, the device comprising:
a ventilation unit including an outdoor air intake path having an outdoor-air opening and an supply-air opening disposed on opposite ends thereof, and an indoor air discharge path having a return-air opening and an exhaust-air opening disposed on opposite ends thereof, wherein a heat exchanger is disposed between the outdoor air intake path and the indoor air discharge path; and
an oxygen supply unit including a compression module that compresses air and an adsorption module that adsorbs nitrogen from the air compressed by the compression module,
wherein a first delivery part that connects the outdoor air intake path with an internal path of the oxygen supply unit is provided between the ventilation unit and the oxygen supply unit, and
wherein a second delivery part that connects the indoor air discharge path with the internal path of the oxygen supply unit is provided between the ventilation unit and the oxygen supply unit.

2. The device of claim 1, wherein the first delivery part delivers a portion of outdoor air flowing through the outdoor air intake path to an interior of the oxygen supply unit, or delivers oxygen separated by the oxygen supply unit to the outdoor air intake path.

3. The device of claim 1, wherein an end portion of the first delivery part is connected to the outdoor air intake path at a position closer to the outdoor-air opening than to the supply-air opening.

4. The device of claim 1, wherein the second delivery part delivers the nitrogen separated in the oxygen supply unit to the indoor air discharge path.

5. The device of claim 1, wherein the ventilation unit comprises:
a ventilation casing;
an outdoor air intake fan disposed in the outdoor air intake path;
an indoor air discharge fan disposed in the indoor air discharge path; and
the heat exchanger disposed between the outdoor air intake path and the indoor air discharge path,
wherein the oxygen supply unit comprises:
an oxygen supply casing;
the compression module disposed inside the oxygen supply casing and configured to compress air; and
the adsorption module disposed inside the oxygen supply casing and provided with an adsorption bed that adsorbs the nitrogen from the air compressed by the compression module,
wherein the first delivery part and the second delivery part are disposed between the ventilation casing and the oxygen supply casing.

6. The device of claim 1, wherein the oxygen supply unit and the supply-air opening are connected to each other by an oxygen delivery pipe, wherein the oxygen supply unit discharges oxygen separated by the adsorption module to the oxygen delivery pipe.

7. The device of claim 1, wherein the oxygen supply unit and an indoor space are connected to each other by an oxygen supply pipe, wherein the oxygen supply unit discharges oxygen separated by the adsorption module to the oxygen supply pipe.

8. The device of claim 1, wherein the oxygen supply pipe branches into a plurality of oxygen branch pipes connected respectively to a plurality of indoor spaces partitioned from each other, wherein an oxygen valve is disposed in each of some or all of the plurality of oxygen branch pipes.

9. The device of claim 8, wherein the oxygen supply unit and the indoor spaces are connected to each other by an indoor air supply pipe independent of the oxygen supply pipe, and indoor air from the indoor spaces is delivered to the compression module through the indoor air supply pipe.

10. The device of claim 9, wherein the indoor air supply pipe branches into a plurality of indoor air branch pipes connected respectively to the plurality of indoor spaces partitioned from each other, wherein an indoor-air valve is disposed in each of some or all of the plurality of indoor air branch pipes.

11. The device of claim 7, wherein the supply-air opening and the indoor space are connected to each other by an outdoor air intake pipe, and the return-air opening and the indoor space are connected to each other by an indoor air discharge pipe independent of the outdoor air intake pipe, and
wherein the oxygen supply pipe forms a path independent of a path of the outdoor air intake pipe.

12. The device of claim 1, wherein a delivery fan is disposed in the oxygen supply unit so as to face the first delivery part.

13. The device of claim 12, wherein the delivery fan rotates in a first direction to draw in outdoor air from the outdoor air intake path, or rotates in a second direction to discharge gas inside the oxygen supply unit to the outdoor air intake path.

14. The device of claim 1, wherein the first delivery part and the second delivery part are provided with a first delivery damper and a second delivery damper, respectively.

15. The device of claim 1, wherein the ventilation unit is provided with a ventilation damper that opens and closes the return-air opening, wherein the ventilation damper is disposed between the second delivery part and the return-air opening, or the second delivery part is disposed between the ventilation damper and the return-air opening.

16. The device of claim 1, wherein the ventilation unit is provided with a bypass path that connects the second delivery part with the exhaust-air opening.

17. The device of claim 8, wherein the outdoor air intake pipe branches into a plurality of outdoor air branch pipes connected respectively to the plurality of indoor spaces partitioned from each other, wherein an outdoor air intake damper is disposed in each of some or all of the plurality of outdoor air branch pipes.

18. A ventilation method using a ventilation device having an oxygen-supplying function and comprising a ventilation unit including an outdoor air intake path having an outdoor-air opening and an supply-air opening disposed on opposite ends thereof, and an indoor air discharge path having a return-air opening and an exhaust-air opening disposed on opposite ends thereof, wherein a heat exchanger is disposed between the outdoor air intake path and the indoor air discharge path, and an oxygen supply unit including a compression module that compresses air and an adsorption module that adsorbs nitrogen from the air compressed by the compression module, the method comprising:
determining, by a controller, oxygen concentration and carbon dioxide concentration in an indoor space, and temperature difference between the indoor space and an outdoor space; and
performing, by the controller, one of a ventilation mode, a ventilation and oxygen supply mode, an outdoor air utilization oxygen supply mode, and an indoor air utilization oxygen supply mode for the indoor space on the basis of the oxygen concentration, the carbon dioxide concentration, and the temperature difference,
wherein in the ventilation mode, an operation of the oxygen supply unit is stopped, and only the ventilation unit operates to ventilate the indoor space,
in the ventilation and oxygen supply mode, the ventilation unit and the oxygen supply unit operate simultaneously, so that the indoor space is ventilated and oxygen is supplied to the indoor space,
in the outdoor air utilization oxygen supply mode, the oxygen supply unit separates oxygen from outdoor air introduced through the outdoor-air opening and supplies the oxygen to the indoor space, and
in the indoor air utilization oxygen supply mode, indoor air from the indoor space is supplied to the oxygen supply unit, and oxygen is separated from the indoor air by the oxygen supply unit and supplied to the indoor space.

19. The method of claim 18, wherein a first delivery part is provided between the ventilation unit and the oxygen supply unit to connect the outdoor air intake path with an internal path of the oxygen supply unit, and
wherein in the ventilation and oxygen supply mode, a portion of the outdoor air is supplied into the oxygen supply unit through the first delivery part.

20. The method of claim 18, wherein a first delivery part is provided between the ventilation unit and the oxygen supply unit to connect the outdoor air intake path with an internal path of the oxygen supply unit, and
wherein in the indoor air utilization oxygen supply mode, the indoor air is supplied into the oxygen supply unit through an indoor air supply pipe that connects the oxygen supply unit with the indoor space.
